(19) United States
(12) Patent Application Publication
(10) Pub. No.: US 2003/0035643 A1
(43) Pub. Date: Feb. 20, 2003

(54) Structure for attaching an optical fiber to a planar waveguide and method thereof

(75) Inventors: Renyuan Gao, Wayne, PA (US); Anthony F. Garito, Radnor, PA (US)

Correspondence Address: JOSEPH E. MAENNER, Monte & McGraw, P.C., P.O. Box 650, 4007 Skippack Pike, Skippack, PA, 19474, US

(73) Assignee: Photon-X, Inc., Malvern, PA

(21) Appl. No.: 10/218,693

(22) Filed: Aug. 14, 2002

Related U.S. Application Data
(60) Provisional application No. 60/313,285, filed on Aug. 17, 2001.

(51) Int. Cl. G02B 6/10; G02B 6/30

(52) U.S. Cl. 385/132; 385/49; 385/50

(57) ABSTRACT

A planar optical waveguide is provided. The waveguide includes a substrate having a top surface, a first end, an opposing second end, and a first channel extending from the first end toward the second end along the top surface. The first channel has a first sidewall extending toward the second end, a second sidewall extending toward the second end, and an endwall engaging the first sidewall and the second sidewall. A cladding layer is disposed on the top surface of the substrate. A core is disposed within the cladding layer. The core has a first end generally co-planar with the endwall and a second end. A method of manufacturing the waveguide and connecting the waveguide to an optical fiber is also provided.

### CROSS-REFERENCE TO RELATED APPLICATIONS

This application claims the benefit of U.S. Provisional Patent Application No. 60/313,285, filed Aug. 17, 2001.

### FIELD OF THE INVENTION

The present invention relates to methods of and structures for connecting optical fibers to planar optical waveguides.

### BACKGROUND OF THE INVENTION

Planar optical waveguides can be formed by disposing a cladding material on a planar substrate, with a core material disposed within the cladding material, such that the core material has a higher refractive index than the cladding material in the near infrared region of the optical telecommunication wavelength window. An optical signal can be transmitted through the core material without significant loss into the cladding material through total internal reflection. Various optical devices, such as integrated splitters, couplers, arrayed waveguide gratings, and optical waveguide amplifiers can be formed with planar optical waveguides. In order to insert a planar optical waveguide into an optical fiber communication necessary, it is essential to be able to accurately and economically connect optical fibers to the planar optical waveguide. It would also be desirable to have a low loss and reliable attachment method for attaching optical fiber to a planar waveguide.

Known technology for connecting optical fibers to planar optical waveguides uses adhesive bonding, such as epoxy, combined with precision alignment before and during the bonding process. This method requires additional components, such as a silicon V-groove array or a fiber capillary tube sub-assembly. In addition, alignment of the fiber with the planar optical waveguide requires a high precision six-degrees of freedom alignment station. Due to the fact that single mode optical fiber cores and single mode planar waveguide cores have dimensions on the order of micrometers, the alignment tolerance to achieve acceptable levels of optical loss is on the sub-micron level.

Furthermore, with long exposure to signal light and secondary light, such as upconversion, emission light, and spontaneous light, as well as environmental changes, the adhesive in the optical path between the fiber and the planar optical waveguide can suffer from aging, resulting in optical absorption and scattering induced performance degradation. It is therefore desirable to provide a structure and a method for attaching optical fibers to planar optical waveguides without requiring precision alignment and adhesive bonding.

### BRIEF SUMMARY OF THE INVENTION

Briefly, the present invention provides a planar optical waveguide. The waveguide comprises a substrate having a top surface, a first end, and a first channel extending from the first end toward the second end along the top surface. The first channel has a first sidewall extending toward the second end, a second sidewall extending toward the second end, and an endwall engaging the first sidewall and the second sidewall. A cladding layer is disposed on the top surface of the substrate. A core is disposed within the cladding layer. The core has a first end generally co-planar with the endwall and a second end.

Additionally, the present invention provides an optical waveguide assembly. The assembly comprises a planar waveguide including a substrate having a top surface, a first end, and a first channel extending from the first end toward the second end along the top surface. The first channel has a first sidewall extending toward the second end, a second sidewall extending toward the second end, and an endwall engaging the first sidewall and the second sidewall. A cladding layer is disposed on the top surface of the substrate and a core is disposed within the cladding layer. The core has a first end generally co-planar with the endwall and a second end. The assembly further comprises a first optical fiber disposed in the first channel. The first optical fiber has a first free end. The first optical fiber is comprised of a cladding and a fiber core disposed within the cladding. The fiber core is in optical alignment with the first end of the waveguide core.

Further, the present invention provides a method of manufacturing a planar optical waveguide. The method comprises providing a generally planar substrate having a first end, a second end, and a top surface; forming a channel in the top surface extending from the first end toward the second end; disposing a first cladding material onto the top surface; forming a core on the first cladding material, the core having a first end optically aligned with the channel; and disposing a second cladding material over the core.

Also, the present invention provides a method of manufacturing an optical waveguide assembly. The method comprises providing a planar optical waveguide including a substrate having a top surface, a first end, an opposing second end, and a first channel extending from the first end toward the second end along the top surface, the first channel having a first sidewall extending toward the second end, a second sidewall extending toward the second end, and an endwall engaging the first sidewall and the second sidewall; a cladding layer disposed on the top surface of the substrate; and a core disposed within the cladding layer, the core having a first end generally co-planar with the endwall and a second end. The method further comprises disposing a first optical fiber in the first channel, the first optical fiber having a first free end, the first optical fiber being comprised of a cladding and a fiber core disposed within the cladding, the fiber core being in optical alignment with the first end of the waveguide core.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a perspective view of a planar optical waveguide according to a first embodiment of the present invention.

FIG. 2 is sectional view of the planar optical waveguide taken along line 2-2 of FIG. 1.

FIG. 3 is a plan view of an alternate embodiment of the planar optical waveguide according to the present invention.

FIG. 4 is a plan view of an alternate embodiment of the planar optical waveguide according to the present invention.

FIG. 5 is a perspective view of a planar optical waveguide assembly incorporating the planar optical waveguide of FIGS. 1 and 2.

FIG. 6 is a plan view of a planar optical waveguide assembly according to an alternate embodiment of the present invention.

FIG. 7 is a side view of a waveguide prior to applying a mask.

FIG. 8 is a side view of the waveguide of FIG. 7 after the mask is applied.

FIG. 9 is a side view of the waveguide of FIG. 8 after the channel is formed.

FIG. 10 is an end view of a planar optical waveguide according to an alternate embodiment of the present invention.

### DETAILED DESCRIPTION OF THE INVENTION

In the drawings, like numerals indicate like elements throughout. As used herein, a first element is said to be in optical alignment with, or optically aligned with, a second element, when signal light can be transmitted between the first and second elements.

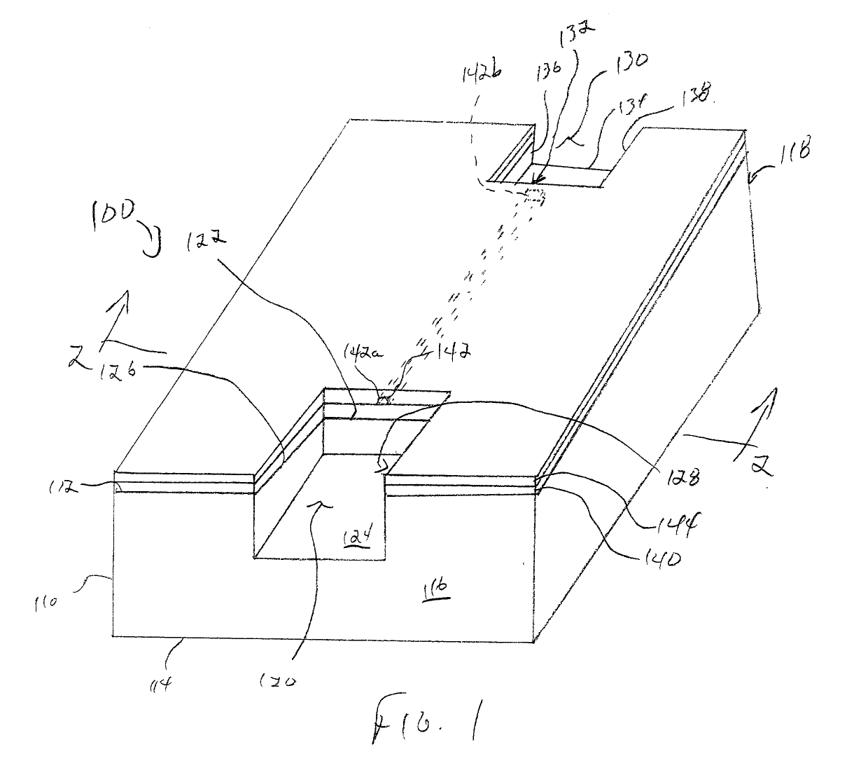

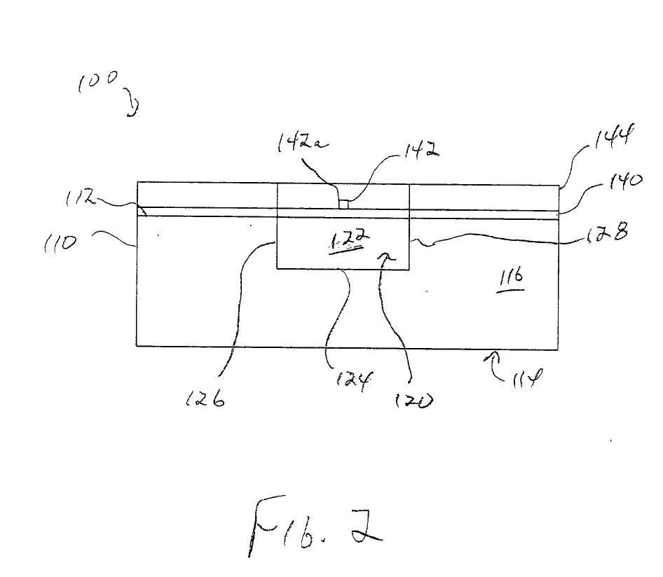

A first preferred embodiment of a planar optical waveguide 100 according to the present invention is shown in FIGS. 1 and 2. The waveguide 100 includes a generally planar substrate 110. Preferably, the substrate 110 is constructed from a plastic, such as polycarbonate, acrylic, polymethyl methacrylate, cellulosic, thermoplastic elastomer, ethylene butyl acrylate, ethylene vinyl alcohol, ethylene tetrafluoroethylene, fluorinated ethylene propylene, polyetherimide, polyethersulfone, polyetheretherketone, polyperfluoroalkoxyethylene, nylon, polybenzimidazole, polyester, polyethylene, polynorbornene, polyimide, polystyrene, polysulfone, polyvinyl chloride, polyvinylidene fluoride, ABS polymers, polyacrylonitrile butadiene styrene, acetal copolymer, poly[2,2-bistrifluoromethyl-4,5-difluoro-1,3-dioxole-co-tetrafluoroethylene] (sold under the trademark TEFLON® AF), poly[2,3-(perfluoroalkenyl) perfluorotetrahydrofuran] (sold under the trademark CYTOP®), poly[2,2,4-trifluoro-5-trifluoromethoxy-1,3-dioxole-co-tetrafluoroethylene] (sold under the trademark HYFLON®), and any other thermoplastic polymers; and thermoset polymers, such as diallyl phthalate, epoxy, furan, phenolic, thermoset polyester, polyurethane, and vinyl ester. However, those skilled in the art will recognize that a blend of at least two of the polymers listed above, or other polymers, can be used. Although the substrate 110 is preferably constructed from a polymer, those skilled in the art will recognize that the substrate 110 can be constructed from other materials, such as silicon. The substrate 110 has a top surface 112 and a bottom surface 114. The substrate 110 also has a first end 116 and an opposing second end 118, generally parallel to the first end 116.

The waveguide 100 includes a generally U-shaped first channel 120 cut into the top surface 112 of the substrate 110 approximately 5 millimeters long, 125 microns wide, and 65 microns deep. The first channel 120 extends from the first end 116 of the substrate 110 toward the second end 118 of the substrate 110. The first channel 120 includes a first sidewall 122 which extends generally perpendicular to the top surface 112 of the substrate 110 from the top surface 112 of the substrate 110 toward the bottom surface 114 of the substrate 110 and from the first end 116 toward the second end 118, and a second sidewall 124 which extends from the top surface 112 of the substrate 110 toward the bottom surface 114 of the substrate 110 and from the first end 116 toward the second end 118. The first and second sidewalls 122, 124 are generally parallel to each other. An endwall 126 also extends generally perpendicular to the top surface 112 of the substrate 110 from the top surface 112 of the substrate 110 toward the bottom surface 114 of the substrate 110, and connects the first sidewall 122 and the second sidewall 124. A bottom wall 128 extends generally parallel to the top surface 112, and connects the first sidewall 122, the second sidewall 124, and the endwall 126.

Preferably, a generally U-shaped second channel 130 is also cut into the substrate 110 approximately 5 millimeters long, 125 microns wide, and 65 microns deep. The second channel 130 extends from the second end 118 of the substrate 110 toward the first end 116 of the substrate 110. The second channel 130 includes a first sidewall 132 which extends generally perpendicular to the top surface 112 of the substrate 110 from the top surface 112 of the substrate 110 toward the bottom surface 114 of the substrate 110 and from the second end 118 toward the first end 116, and a second sidewall 134 which extends from the top surface 112 of the substrate 110 toward the bottom surface 114 of the substrate 110 and from the second end 118 toward the first end 116. The first and second sidewalls 132, 134 are generally parallel to each other. An endwall 136 also extends generally perpendicular to the top surface 112 of the substrate 110 from the top surface 112 of the substrate 110 toward the bottom surface 114 of the substrate 110, and connects the first sidewall 132 and the second sidewall 134. A bottom wall 138 extends generally parallel to the top surface 112, and connects the first sidewall 132, the second sidewall 134, and the endwall 136.

An undercladding 140 is disposed on the top surface 112 of the substrate 110. Preferably, the undercladding 140 is constructed from an optical polymer, although those skilled in the art will recognize that other materials, such as optical glasses, can be used. Preferably, the undercladding 140 is approximately between 10 and 20 microns thick, although those skilled in the art will recognize that the undercladding 140 can be other thicknesses as well.

A core 142 is disposed on a portion of the undercladding 140. The core 142 has a first end 142a that is generally flush with the closed end 122 of the first channel 120, and a second end 142b that is generally flush with the closed end 132 of the second channel 130. The core 142 extends between the first channel 120 and the second channel 130. The first and second channels 120, 130 are each sized such that an optical fiber can be disposed in each of the first and second channels 120, 130, with a core of each optical fiber being in optical alignment with one of the first and second ends 142a, 142b of the core 142 of the waveguide 100.

Those skilled in the art will recognize that the core 142 can be generally straight or curved. Preferably, the core 142 is constructed from an optical polymer, although those skilled in the art will recognize that other materials, such as optical glasses, can be used. Preferably, the core 142 is approximately between 3 and 10 microns thick, although those skilled in the art will recognize that the core 142 can be other thicknesses as well.

An overcladding 144 is disposed on the core 142 and the portion of the undercladding 140 not covered by the core 142, such that the core 142 is generally surrounded by the undercladding 140 and the overcladding 144, with the exception of the first end 142a and the second end 142b of the core 142. Preferably, the overcladding 144 is constructed from an optical polymer, although those skilled in the art will recognize that other materials, such as optical glasses, can be used. Preferably, the overcladding 144 is approximately between 10 and 20 microns thick, although those skilled in the art will recognize that the overcladding 144 can be other thicknesses as well.

Although only one first channel 120 is shown proximate the first end 116, those skilled in the art will recognize that more than one first channel 120 can be formed proximate the first end 116. Similarly, although only one second channel 130 is shown proximate the second end 118, those skilled in the art will recognize that more than one second channel 130 can be formed proximate the second end 118. Also, while only a single core 142 is shown, those skilled in the art will recognize that other configurations with multiple cores 142, such as an arrayed waveguide grating (AWG) can be used as the core 142.

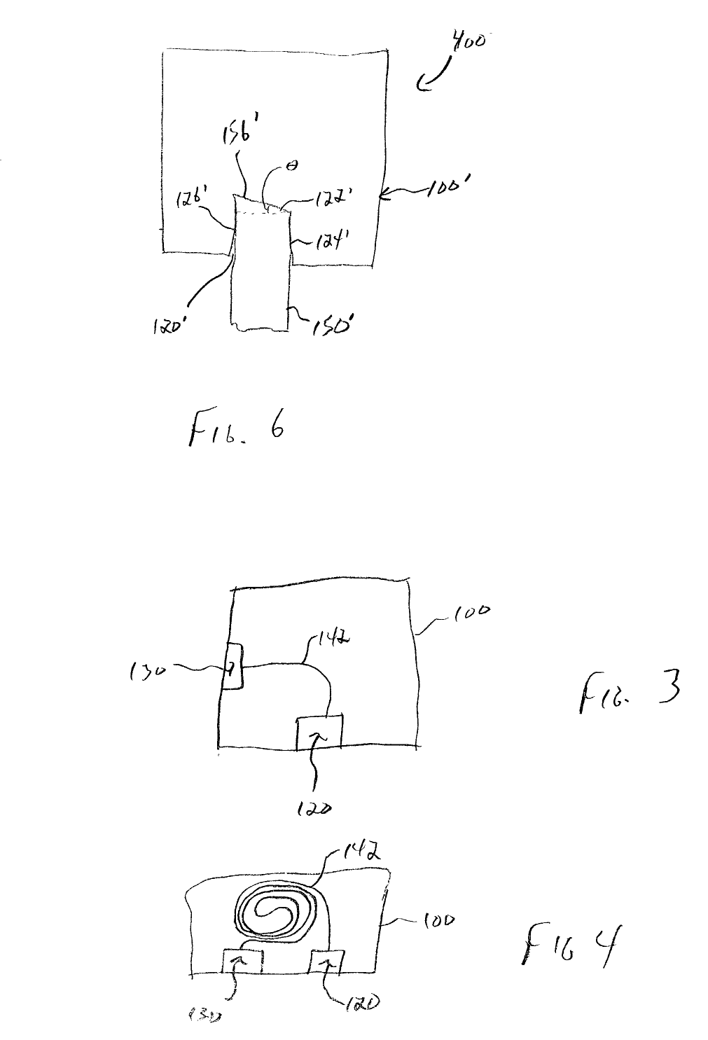

Further, although the second channel 130 is shown in FIG. 1 as being formed proximate the second end 118, those skilled in the art will recognize that the second channel 130 can be formed along any side of the substrate 110, such as the examples shown in FIGS. 3 and 4, so long as the first channel 120 is optically aligned with the second channel 130 through the core 142.

In a particular embodiment, shown in FIG. 5, a single mode optical fiber 150 and a planar optical waveguide 100 are provided in a planar optical waveguide assembly 300. The fiber 150 has a diameter of the cladding 152 of approximately 125 microns, with a diameter of the core 154 of approximately 9 microns.

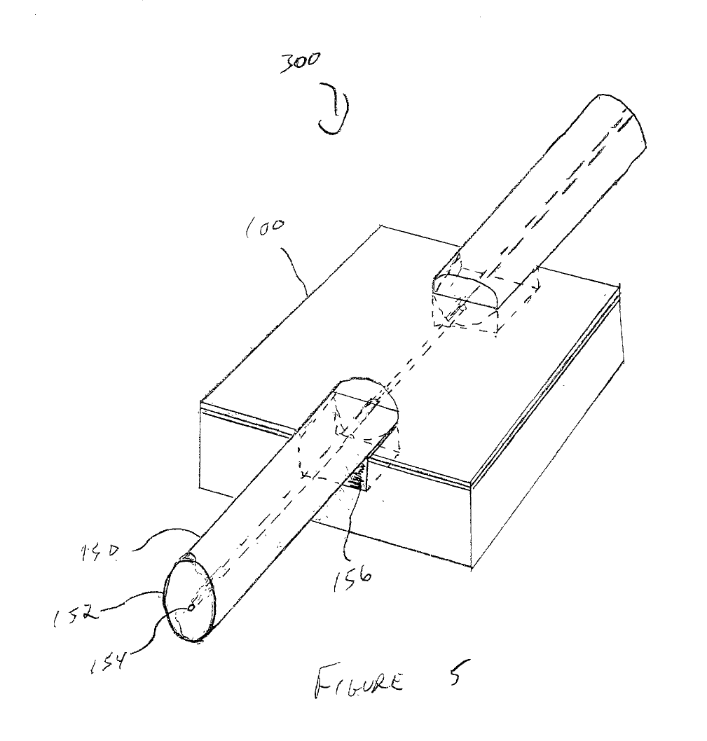

In an alternate embodiment of the present invention, shown in plan view in FIG. 6, a planar waveguide assembly 400 incorporates a planar waveguide 100′, with an optical fiber 150′ disposed in a channel 120′ in the waveguide 100′. The channel 120′ is comprised of a first sidewall 124′, a second sidewall 126′ and an end wall 122′, connecting the first sidewall 124′ and the second sidewall 126′. However, unlike the waveguide 100 shown in FIGS. 1-3, in which the endwall 122 connects each of the sidewalls 124, 126 at generally right angles, the endwall 122′ connects one of the endwalls 124′, 126′ at an angle θ beyond a right angle. Further, the fiber 150′ is cut such that the fiber end 156′ has a matching angle θ. In an embodiment, the angle θ is approximately 8°, although those skilled in the art will recognize that angles other than 8° can be used. The 8° angle is selected to minimize back reflection of light transmitted through the waveguide assembly 400 at the interface between the fiber end 156′ and the endwall 122′.

A method of manufacturing waveguide 100 as described above is now provided. The waveguide 100′ is manufactured according to the same process, and its manufacture needs not be described.

Undercladding 140 on the substrate 110 is approximately between 10 and 20 microns thick, with a waveguide core 142 disposed on the undercladding 140 being approximately between 3 and 10 microns thick. Overcladding 144 extends above the undercladding 140 approximately between 10 and 20 microns. The waveguide core 142 can be manufactured according to well known methods for planar optical waveguide core manufacturing.

The first and second channels 120, 130 can be formed by at least one of several methods, including molding or stamping the channels 120, 130 into the substrate 110, laser ablation or reactive ion etching of material from the substrate 110, or other methods known by those skilled in the art.

The first and second channels 120, 130 can be formed prior to applying the undercladding 140, the core 142 and the overcladding 144, or after applying the undercladding 140, the core 142 and the overcladding 144. The preferred methods of forming the first and second channels 120, 130 prior to applying the undercladding 140, the core 142 and the overcladding 144 are by molding, wherein the shape of the first and second channels 120, 130 are formed in the substrate 110 during manufacture of the substrate 110, such as by injection molding of the substrate 110, or by stamping, wherein the substrate 110 is heated beyond its glass transition temperature and a stamp is pressed into the substrate 110 to form the first and second channels 120, 130.

In any of the methods by which the first and second channels 120, 130 are formed prior to applying the undercladding 140, the core 142 and the overcladding 144, after the first and second channels 120, 130 are formed, a soluble filler (not shown) is disposed within each of the first and second channels 120, 130. The undercladding 140, the core 142 and the overcladding 144 are then formed on the substrate 110, with portions of the undercladding 140, the core 142 and the overcladding 144 overlaying the first and second channels 120, 130 being removed, such as by reactive ion etching, forming the waveguide 100. The waveguide 100 is then placed in a suitable solution to dissolve the soluble filler. An example of a filler and solvent are polyvinyl alcohol (PVA) and water.

The preferred methods of forming the first and second channels 120, 130 after applying the undercladding 140, the core 142 and the overcladding 144 are by laser ablation, wherein a continuous wave or a pulsed laser is focused over a portion of the substrate 110 to be removed, forming the first and second channels 120, 130, or by reactive ion etching, wherein a mask is applied over the portion of the substrate 110 that is not to be etched, and the remaining portion of the substrate 110 is etched away, forming the first and second channels 120, 130.

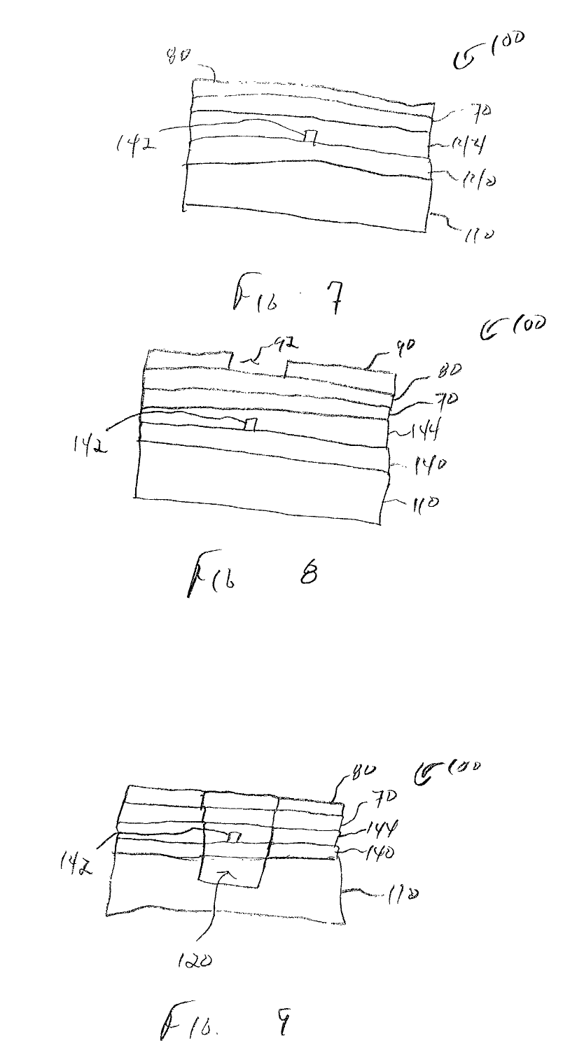

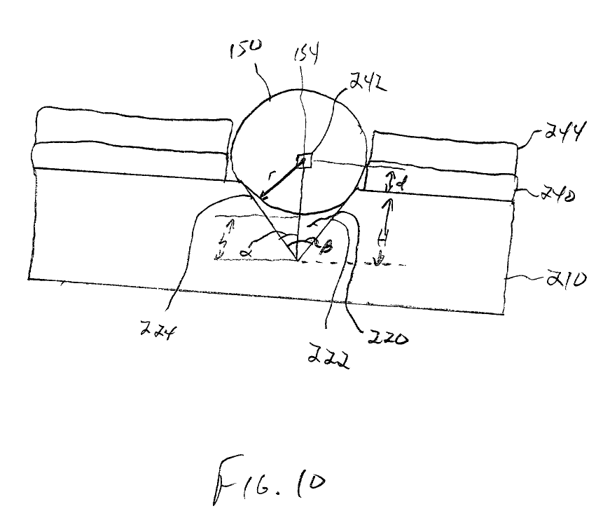

For reactive ion etching of the substrate 110, referring to FIG. 7, the top of the overcladding 144 is metallized with a metal such as aluminum or gold, forming a metal layer 70, as is well known in the art. A photoresist layer 80 is then applied over the metal layer 70. Referring to FIG. 8, an etching mask 90 is disposed on the top of the photoresist layer 80. The mask 90 includes a mask opening 92 corresponding to the first channel 120 that is to be etched anisotropically into the substrate 110. The mask 90 is exposed to ultraviolet light to form an etching pattern on the photoresist layer 80. Due to a slight isotropic effect, in which the etching extends generally horizontally approximately 2.5 microns beyond the mask opening 92, the mask opening 92 is 5 microns narrower than the desired width of the first channel 120. The mask 90 is removed and the reactive ion etcher (not shown) etches through the photoresist layer 80, the metal layer 70 and the substrate 110 to form the first channel 120, as shown in FIG. 9. The photoresist layer 80 and the metal layer 70 are subsequently removed in processes known to those skilled in the art. A detailed process for a method of manufacturing the first channel 120 is disclosed in U.S. Provisional Patent Application Serial No. 60/382,414, which is owned by the assignee of the present invention and is incorporated herein by reference in its entirety.

In an embodiment, such as the embodiment demonstrated in FIGS. 7-9, in which a single 125 micron wide channel is desired, the mask opening 62 is 120 microns wide.

The 10 to 20 micron undercladding layer 140 locates the waveguide core 142 approximately 10 to 20 microns above the bottom wall 128 of the first channel 120, such that, when the fiber is inserted into the first channel 120, as shown in FIG. 3, the fiber core 154 is in optical alignment with the waveguide core 142. Prior to inserting the fiber 150 into the first channel 120, an adhesive 156, such as an epoxy, is applied to at least one of the fiber 150 and the first channel 120, so that the fiber 150 is securely fastened to the substrate 110.

Optionally, a cover (not shown) can be applied to the top of the waveguide 100. The cover can serve to more fully secure the fiber 150 to the waveguide 100. A channel (not shown) can be formed in the cover to accommodate a portion of the fiber 150 that extends above the overcladding 144.

In an alternate embodiment, shown in FIG. 10, a waveguide 200 includes a generally V-shaped first channel 220 cut into a first end 212 of a substrate 210. Preferably, the first channel 220 includes a first sidewall 222 and a second sidewall 224, with an angle β between the first and second sidewalls 222, 224. Preferably, the angle β is approximately 70.5 degrees, although those skilled in the art will recognize that the angle β can be other values as well. The value 70.5 degrees is adapted from known technology of manufacturing V-grooves in silicon-based substrates, in which 70.5 degrees is an optimum cleaving angle for silicon-based crystals.

Referring to FIG. 10, an optimum height for the center of the fiber core 154 for a fiber 150 above the substrate 210 can be readily calculated by the equation:

H+d=r+h (Equation 1)

where:

H is the vertical distance between the bottom of the channel 220 and the top of the substrate 210;

d is the vertical distance between the center of the core 242 and the top of the substrate 210;

r is the radius of the fiber 150; and

h is the vertical distance between the bottom of the channel 220 and the bottom of the fiber 150.

“h” is defined by the equation:

h=(r/sin α−r) (Equation 2)

where α=β/2.

For a standard single mode fiber having a diameter of 125 microns, “r” is fixed at 62.5 microns. For a fixed β of 70.5 degrees, “h” is fixed at approximately 36 microns. “H” and “d” are adjustable, so long as the sum of “H” and “d” satisfy Equation 1. As is well known in the art, the thickness of the undercladding 240, the core 242, and the overcladding 242 can be adjusted by the speed and duration of the spincoating process which applies the undercladding 240, the core 242, and the overcladding 244 in solution form onto the substrate 210. Such a known process allows the value for “d” to be predetermined, and the value of “H” is calculated to satisfy Equation 1.

As with the embodiment of the waveguide 100, a second channel (not shown) can be formed in a second end of the substrate 210, distal from the first end 212, and that multiple channels 220 can be formed in the first end 212. Alternately, the second channel can be formed in any side of the substrate 210, so long as the first channel 220 is optically aligned with the second channel through the core 242.

Preferably, the V-shaped first channel 220 is formed in the substrate 210 by molding or stamping, as describe above relative to the formation of the first and second channels 120, 130 in the substrate 110, although those skilled in the art will recognize that other methods can be used.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A planar optical waveguide comprising:
a substrate having a top surface, a first end, an opposing second end, and a first channel extending from the first end toward the second end along the top surface, the first channel having a first sidewall extending toward the second end, a second sidewall extending toward the second end, and an endwall engaging the first sidewall and the second sidewall;
a cladding layer disposed on the top surface of the substrate; and
a core disposed within the cladding layer, the core having a first end generally co-planar with the endwall and a second end.

2. The planar optical waveguide according to claim 1, wherein the first channel further comprises a bottom wall engaging the first sidewall, the second sidewall, and the endwall.

3. The planar optical waveguide according to claim 2, wherein the first sidewall and the second sidewall are generally parallel to each other.

4. The planar optical waveguide according to claim 3, wherein the first sidewall is spaced from the second sidewall by approximately 125 micrometers.

5. The planar optical waveguide according to claim 2, wherein the first channel is generally U-shaped.

6. The planar optical channel according to claim 1, wherein the first channel is generally V-shaped.

7. The planar optical waveguide according to claim 1, wherein the substrate is constructed from a polymer.

8. The planar optical waveguide according to claim 1, wherein the first channel is constructed by one of molding, laser ablation, reactive ion etching, and stamping.

9. The planar optical waveguide according to claim 1, further comprising a second channel extending from the second end toward the first end along the top surface, the second channel having an endwall, the second end of the core being in optical alignment with the endwall of the second channel, the second end of the core being generally co-planar with the endwall of the second channel.

10. The planar optical waveguide according to claim 1, further comprising a second channel extending into the substrate, wherein the second channel is optically aligned with the first channel through the core.

11. An optical waveguide assembly comprising:
a planar waveguide including:
a substrate having a top surface, a first end, an opposing second end, and a first channel extending from the first end toward the second end along the top surface, the first channel having a first sidewall extending toward the second end, a second sidewall extending toward the second end, and an endwall engaging the first sidewall and the second sidewall;
a cladding layer disposed on the top surface of the substrate; and
a core disposed within the cladding layer, the core having a first end generally co-planar with the endwall and a second end; and
a first optical fiber disposed in the first channel, the first optical fiber having a first free end, the first optical fiber being comprised of a cladding and a fiber core disposed within the cladding, the fiber core being in optical alignment with the first end of the waveguide core.

12. The optical waveguide assembly according to claim 11, wherein the first free end of the first optical fiber is in engaging contact with the endwall of the first channel.

13. The optical waveguide assembly according to claim 11, wherein the planar waveguide further comprises a second channel extending from the second end toward the first end along the top surface, the second channel having an endwall, the second end of the core being generally co-planar with the endwall of the second channel, and wherein the optical waveguide assembly further comprises a second optical fiber disposed in the second channel, the second optical fiber having a second free end, the second optical fiber being comprised of a cladding and a fiber core disposed within the cladding, the fiber core being in optical alignment with the second end of the core.

14. The optical waveguide assembly according to claim 13, wherein the second free end of the second optical fiber is in engaging contact with the endwall of the second channel.

15. The optical waveguide assembly according to claim 11, wherein the first optical fiber engages both the first and second sidewalls of the first channel.

16. A method of manufacturing a planar optical waveguide comprising:
providing a generally planar substrate having a first end, a second end, and a top surface;
forming a channel in the top surface extending from the first end toward the second end;
disposing a first cladding material onto the top surface;
forming a core on the first cladding material, the core having a first end optically aligned with the channel; and
disposing a second cladding material over the core.

17. The method according to claim 16, wherein forming the channel is performed by one of injection molding, laser ablation, reactive ion etching, and stamping.

18. The method according to claim 16, wherein forming the channel is performed after disposing the first cladding material onto the substrate, and forming the channel also comprises forming the channel through the first cladding material.

19. The method according to claim 16, wherein forming the channel is performed prior to disposing the first cladding material onto the substrate.

20. The method according to claim 16, further comprising forming a second channel in the top surface extending from the second end toward the first end.

21. The method according to claim 16, further comprising, after forming the channel, disposing a filler in the channel and, after disposing the second cladding material over the core, removing the filler material.

22. A method of manufacturing an optical waveguide assembly comprising:
providing a planar optical waveguide including:
a substrate having a top surface, a first end, an opposing second end, and a first channel extending from the first end toward the second end along the top surface, the first channel having a first sidewall extending toward the second end, a second sidewall extending toward the second end, and an endwall engaging the first sidewall and the second sidewall;
a cladding layer disposed on the top surface of the substrate; and
a core disposed within the cladding layer, the core having a first end generally co-planar with the endwall and a second end; and
disposing a first optical fiber in the first channel, the first optical fiber having a first free end, the first optical fiber being comprised of a cladding and a fiber core disposed within the cladding, the fiber core being in optical alignment with the first end of the waveguide core.

23. The method according to claim 22, further comprising providing the planar optical waveguide having a second channel extending from the second end toward the first end and disposing a second optical fiber in the second channel, the secondoptical fiber having a second free end, the second optical fiber being comprised of a cladding and a fiber core disposed within the cladding, the fiber core being in optical alignment with the second end of the waveguide core.
